(19) United States
(12) Patent Application Publication
(10) Pub. No.: US 2002/0175480 A1
(43) Pub. Date: Nov. 28, 2002

(54) Elastically distortable membrane skin

(75) Inventor: Wolfgang Tatzreiter, Dornbirn (AT)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(73) Assignee: VAT Holding AG

(21) Appl. No.: 10/092,092

(22) Filed: Mar. 5, 2002

(30) Foreign Application Priority Data
Mar. 16, 2001 (AT) A415/2001

(51) Int. Cl. F16J 15/52

(52) U.S. Cl. 277/634

(57) ABSTRACT

1. An elastically deformable diaphragm bellows comprises a plurality of ring diaphragms having inner edges and outer edges, wherein the inner edges define an inner opening and the inner edges and outer edges of adjacent ring diaphragms are alternately welded together, and at least one sliding ring which is secured in the inner opening of the diaphragm bellows and which has an inner surface for guiding the diaphragm bellows on a rod and an outer surface whose diameter is smaller than the diameter of the inner edge of the ring diaphragm and which is provided with an annular projection which protrudes radially outward or a plurality of projections which are spaced apart in circumferential direction, which projection or projections protrude(s) into the space between two ring diaphragms and secure(s) the sliding ring in a positive engagement against a displacement in axial direction of the diaphragm bellows, wherein the inner edges of the two ring diaphragms between which the projection or projections of the sliding ring is or are arranged rest on the outer surface of the sliding ring, and the inner edges of adjacent ring diaphragms are also arranged over the outer surface of the sliding ring in the contracted state of the diaphragm bellows.

### BACKGROUND OF THE INVENTION

a) Field of the Invention

The invention is directed to an elastically deformable diaphragm bellows comprising a plurality of ring diaphragms having inner edges and outer edges, wherein the inner edges define an inner opening and the inner edges and outer edges of adjacent ring diaphragms are alternately welded together, and at least one sliding ring with an inner surface for guiding the diaphragm bellows on a rod, which sliding ring is secured in the inner opening of the diaphragm bellows.

b) Description of Related Art

Corrugated bellows are known in which tubes are deformed in the shape of bellows in order, in this way, to achieve a tube that is deformable to a defined extent. Such corrugated bellows are used, for example, to carry out a limited movement in a vacuum.

In contrast, the subject matter of the present application relates to an elastically deformable diaphragm bellows presenting an enveloping wall of elastic, flexible components for sealing between parts which are movable relative to one another to a limited extent, for example, for sealing an actuating spindle inside a housing of a vacuum valve. Embodiment forms of diaphragm bellows of this type are shown, for example, in U.S. Pat. No. 3,108,780 A, U.S. Pat. No. 4,044,993 A, CH 531 666 and FR 1 408 365. Depending on use, a differential pressure occurs between the inside and outside of the diaphragm bellows. The pressure inside the diaphragm bellows can be less than or greater than the pressure outside the diaphragm bellows. Particularly when the pressure inside the diaphragm bellows is greater than the pressure outside the diaphragm bellows, the diaphragm bellows can buckle laterally to various extents (starting from a determined ratio of length and diameter) due to the limited lateral rigidity of the diaphragm bellows. This occurs, for example, when an actuating rod, e.g., a valve rod, is guided through the diaphragm bellows into the interior of a vacuum chamber. Due to the lateral buckling of the diaphragm bellows, areas of its inner wall contact the actuating rod extending into the diaphragm bellows and the inner edges of individual ring diaphragms of the diaphragm bellows rub on the rod when the actuating rod is displaced. This results in wear of varying extent on the welds between the inner edges of the ring diaphragms, so that the strength of these welds may be impaired over the course of time and leakage can occur.

Therefore, in order to reduce rubbing, the rod projecting into the diaphragm bellows is typically provided with a very smooth surface. However, since this can nevertheless not always ensure adequate life of the diaphragm bellows, it has been further suggested to weld rings to the inner side of the diaphragm bellows, which rings are spaced apart in axial direction of the diaphragm bellows and project over the inner edges of the ring diaphragms and serve to guide the rod. In order to reduce rubbing, it has further been suggested that an inner Teflon ring be snapped onto these rings on the inner side, this Teflon ring being slotted for this purpose.

Since the ring diaphragms are made of very thin sheet metal, usually with a thickness between 0.4 mm and 0.06 mm, it is relatively costly to produce a weld for welding the ring without damaging the ring diaphragms. Further, the ring must be made of very high-quality, and therefore expensive material in order to produce a weld of this type. It is further disadvantageous that the Teflon rings that are snapped on to the welded rings can detach as a result of shock, for example.

U.S. Pat. No. 4,650,160 discloses a corrugated bellows comprising a plurality of partial bellows. These partial bellows are welded to one another and sliding rings are inserted in the connection area between these partial bellows in special formed portions of the connection area. In these corrugated bellows, only the bending changes, not the axial expansion. In any case, the axial expansion in these corrugated bellows can change to a much smaller extent in comparison to diaphragm bellows. The possibility of contraction of the corrugated bellows is additionally reduced by the sliding rings inserted between every two partial corrugated bellows in U.S. Pat. No. 4,650,160.

GB 2 062 132 A discloses a corrugated bellows which is stabilized with respect to its omega-shaped individual corrugations relative to a high pressure acting externally. For this purpose, supporting rings are used which are adapted to the shape of the corrugations in all successive corrugations and which contact one another in the contracted state of the corrugated bellows and, together, form a closed tube around the central rod. High externally acting pressures of the kind mentioned above occur particularly in hydraulic applications. The supporting rings accordingly limit the contraction of the corrugated bellows.

JP 63-199965 A discloses a cylinder without a piston rod in which the cylinder wall is formed by a corrugated rubber hose. In order to maintain the corrugations of the rubber hose, rings which constrict the rubber hose are provided on the outer side of the rubber hose and supporting rings which are displaceable on a rod are provided inside the rubber hose. The rings encircling the rubber hose on the outer side, together with the supporting rings arranged therebetween on the inner side, maintain the corrugation of the rubber hose.

### OBJECT AND SUMMARY OF THE INVENTION

An important object of the invention is to provide a diaphragm bellows of the type mentioned in the beginning which can be produced very simply in spite of the arrangement of at least one sliding ring and whose possible change in length is impaired as little as possible.

A further object of the invention is to provide a diaphragm bellows of the type mentioned in the beginning, whose sliding ring ensures a good guidance of the diaphragm bellows.

A further object of the invention is to provide a diaphragm bellows of the kind mentioned in the beginning which enables smooth contraction and expansion of the diaphragm bellows.

A diaphragm bellows, according to the invention, comprises a plurality of ring diaphragms having inner edges and outer edges, wherein the inner edges define an inner opening and the inner edges and outer edges of adjacent ring diaphragms are alternately welded together, and at least one sliding ring which is secured in the inner opening of the diaphragm bellows and which has an inner surface for guiding the diaphragm bellows on a rod and an outer surface whose diameter is smaller than the diameter of the inner edge of the ring diaphragm and which is provided with an annular projection which protrudes radially outward or a plurality of projections which are spaced apart in circumferential direction, which projection or projections protrude(s) into the space between two ring diaphragms and secure(s) the sliding ring in a positive engagement against a displacement in axial direction of the diaphragm bellows, wherein the inner edges of the two ring diaphragms between which the projection or projections of the sliding ring is or are arranged rest on the outer surface of the sliding ring, and the inner edges of adjacent ring diaphragms are also arranged over the outer surface of the sliding ring in the contracted state of the diaphragm bellows.

The sliding ring of a diaphragm bellows, according to the invention, is securely fixed in the interior of the diaphragm bellows; the cost of producing a diaphragm bellows according to the invention is only negligibly higher than that of producing a conventional diaphragm bellows without sliding rings. Also, the possible change in length of the diaphragm bellows is only slightly impaired.

Also, in conventional diaphragm bellows without sliding rings, a plurality of partial bellows were sometimes produced initially, especially when very long diaphragm bellows were to be produced. These partial diaphragm bellows are tested for tightness individually, so that a leaky partial bellows can be immediately rejected. The partial bellows are subsequently connected by a few welds to form a complete diaphragm bellows. This reduces the risk of leakiness in the finished diaphragm bellows which are formed of a great many ring diaphragms and a corresponding number of welds.

The outer surface of the sliding ring advantageously has a diameter that is slightly smaller than the inner opening of the ring diaphragm. When the partial bellows are welded during production of the diaphragm bellows, the partial bellows are accordingly centered by means of the inserted sliding ring so that no additional steps are required for centering the partial bellows. Accordingly, the labor for welding the individual partial bellows can even be reduced compared to a bellows without sliding rings.

The various features and constructions according to the invention are indicated in the claims.

In the following, further advantages and details of the invention are described with reference to the embodiment example shown in the drawing, further objects of the invention also following therefrom.

### BRIEF DESCRIPTION OF THE DRAWINGS

FIG. 1 is a schematic view of a section through the longitudinal center of three partial bellows with the sliding rings to be inserted therebetween;

FIG. 2 shows a side view of a sliding ring;

FIG. 3 shows an enlarged section along line A—A from FIG. 2;

FIG. 4 schematically illustrates the welding process for welding two partial bellows with a sliding ring inserted therebetween;

FIG. 5 shows a section through the longitudinal center of a diaphragm bellows with end pieces arranged thereon and a rod projecting into the diaphragm bellows; and

FIG. 6 shows a side view of a somewhat modified embodiment example of a sliding ring.

### DESCRIPTION OF THE PREFERRED EMBODIMENT EXAMPLES

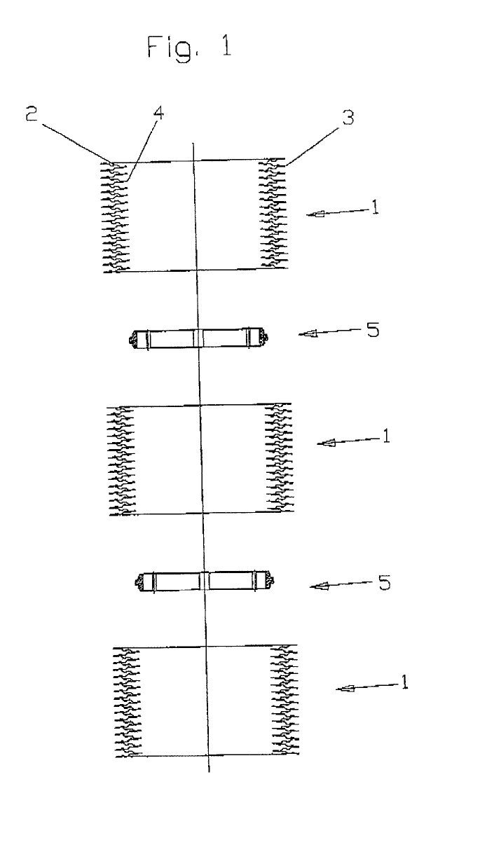

The partial bellows 1 of the diaphragm bellows which are shown in FIG. 1 comprise a plurality of conically shaped, corrugated ring diaphragms 2. The outer edges 3 and inner edges 4 of the successive ring diaphragms are welded together. In order to produce a partial bellows 1, two contacting ring diaphragms 2 are initially welded together by their edges 4. The pair of ring diaphragms are subsequently aligned and welded together by their outer edges 3. A partial bellows can comprise twenty to forty ring diaphragms 2, for example. In addition to the corrugated shape shown in the drawings, other shapes are also conceivable and possible (and known from conventional diaphragm bellows) for ring diaphragms of this kind; for example, the ring diaphragms can be constructed so as to be stepped, considered in cross section.

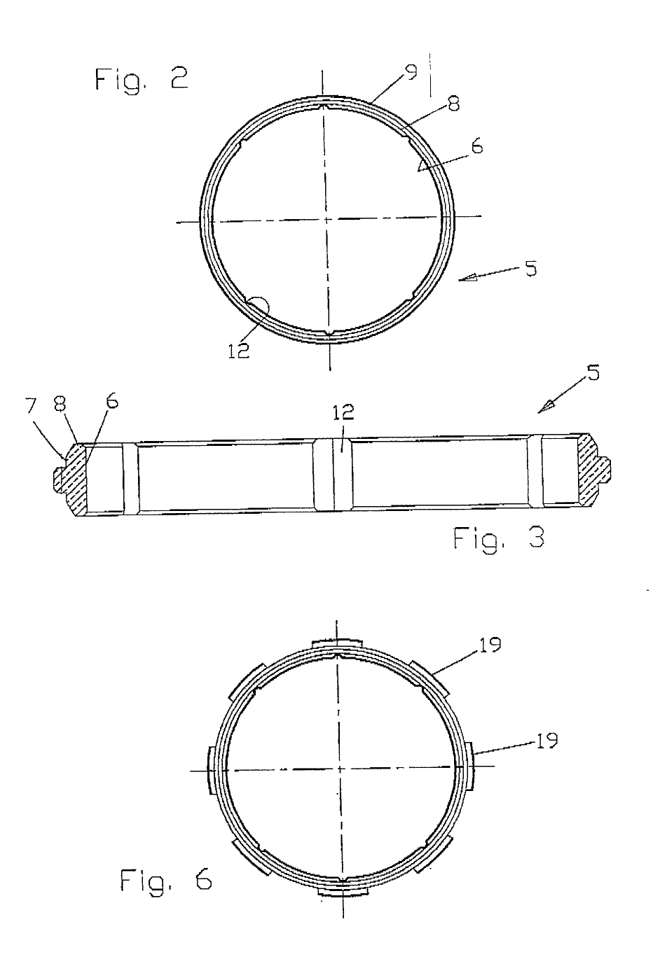

When these partial bellows 1 are welded together, sliding rings 5 according to the invention are placed between the partial bellows. As can be seen from FIGS. 2 and 3, a sliding ring 5 of this kind has an inner surface 6 and an outer surface 7. The inner and outer surfaces 6, 7 are connected with one another by lateral surfaces 8. At its outer surface 7, the sliding ring has an annular projection 9 which projects radially outward and which forms a kind of flange for anchoring the sliding ring between the two opposing edge-side plates 2 of the two partial bellows 1. The inner edges 4 of the ring diaphragms 2 between which the sliding ring 5 is arranged contact the projection 9 on the outer surface 7 of the sliding ring. In the contracted state of the diaphragm bellows (not shown in the drawings), the inner edges 4 of adjacent ring diaphragms 2 can also be arranged over the outer surface 7.

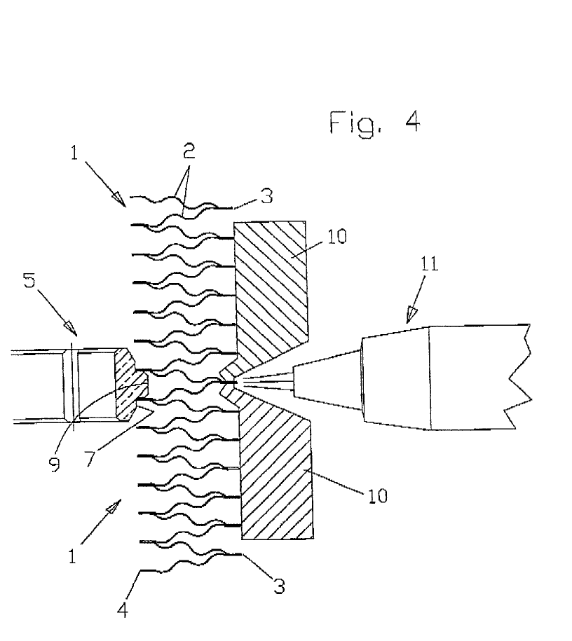

The welding of the two opposing edge-side ring diaphragms 2 of the two partial bellows at the outer edges 3 of these two ring diaphragms is shown schematically in FIG. 4. The outer surface 7 of the sliding ring 5 has a diameter that is slightly smaller than the inner opening of the ring diaphragm 2. The sliding ring inserted between the partial bellows 1 accordingly serves as a guide for centering these two partial bellows 1 relative to one another during welding. Therefore, additional guide devices for centering during welding are not required. The two end-side ring diaphragms are pressed together by metal retaining fingers 10 and are welded together at their outer edge 3 by means of a conventional welding device 11. The sliding ring 5 is consequently immovable with slight radial and axial play and is secured in a positive engagement between the ring diaphragms 2 in the interior of the diaphragm bellows, wherein its inner surface has a smaller diameter than the inner edge 4 of the ring diaphragms 2, that is, the inner surface 6 of the sliding ring protrudes on the inside over the inner edges 4 of the ring diaphragms 2.

Since the two ring diaphragms 2 between which a sliding ring 5 is fitted can not be pressed together completely, the total travel of the diaphragm bellows is reduced slightly; this can be taken into account correspondingly in the design of the diaphragm bellows.

Depending on the length of the diaphragm bellows, a plurality of sliding rings 5 are arranged so as to be spaced apart in axial direction of the diaphragm bellows. The magnitude of the distance between the two sliding rings depends on different factors such as the diameter of the diaphragm bellows. As an approximate value, it has proven successful in practice to estimate the distance of the sliding rings at one to two times, preferably one and a half times to two times, the outer diameter of the diaphragm bellows; this value also applies to the spacing in the relaxed state.

The sliding ring 5 has a plurality of recesses or indentations 12 at its inner surface 6. These indentations form passages so that air can pass between the sliding ring 5 and a rod on which the sliding ring 5 is guided. Facets 13 which are inclined toward the side surfaces 8 are provided at the outer surface 7 of the sliding ring 5 and form inclined entrances or run-in slopes for the ring diaphragms 2 when the diaphragm bellows is contracted. Instead of inclined facets which are constructed in a flat manner, they could also be constructed with a curved surface as a rounded portion toward the side surfaces 8.

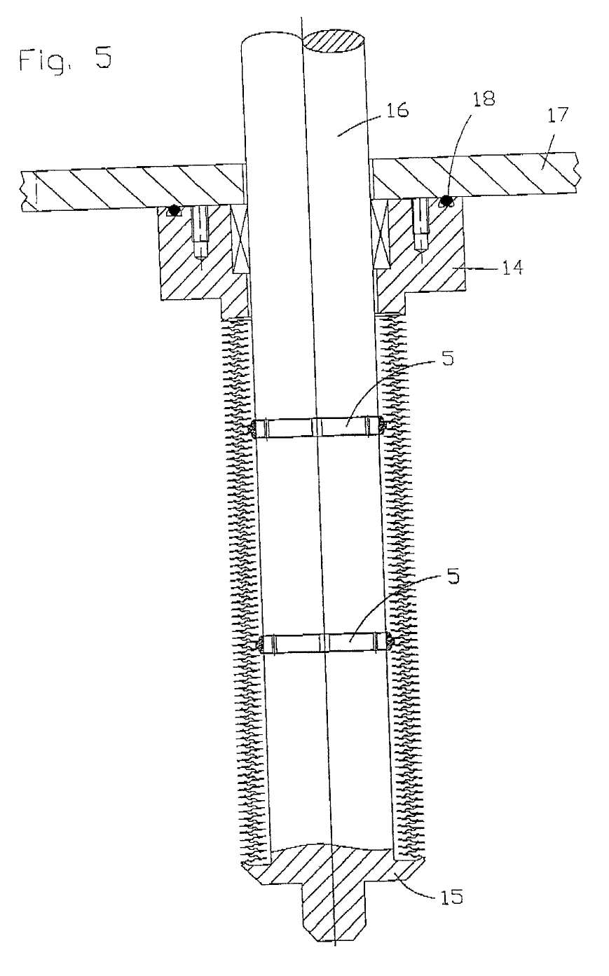

FIG. 5 shows a diaphragm bellows with welded on end pieces 14, 15 which receives a rod 16, the end piece 15 being constructed integral with the rod 16 or formed by the free end of this rod. A sealing ring 18, for example, a Viton O-ring, is provided in a valve seat in the end piece 14 between the end piece 14 and a sealing surface at the wall 17 of a vacuum chamber. The interior of the diaphragm bellows is at atmospheric pressure, while there is a vacuum in the vacuum chamber. The diaphragm bellows is guided on the rod 16 by means of the sliding rings 5, and the sliding rings 5 slide on the rod 16 when the rod 16 is displaced axially and prevent contact between the inner edges 4 of the ring diaphragms 2 and the rod 16.

The sliding rings preferably comprise a material with a low coefficient of friction relative to metal, particularly stainless steel; for example, it is made of an abrasion-resistant plastic or of metal. Suitable plastics are, for example, Teflon (PTFE) and Ertalon. When the sliding rings 5 are made of metal, a bronze alloy having good sliding and emergency running characteristics can also be considered, for example.

A somewhat modified embodiment example of a sliding ring is shown in FIG. 6. Instead of an annular projection, the sliding ring has a plurality of projections 19 which are spaced apart in circumferential direction.

As follows from the preceding description, the field of the invention is not limited to the embodiment examples shown herein, but should be defined with reference to the appended claims together with their full range of possible equivalents.

While the preceding description and the drawings show the invention, it is obvious to the person skilled in the art that various modifications may be implemented without departing from the true spirit and field of the invention.

List of Reference Numbers

```
  1  partial bellows
  2  ring diaphragm
  3  outer edge
  4  inner edge
  5  sliding ring
  6  inner surface
  7  outer surface
  8  side surface
  9  projection
10  retaining finger
11  welding device
12  indentation
13  facet
14  end piece
15  end piece
16  rod
17  wall
18  sealing ring
19  projection
```

1. An elastically deformable diaphragm bellows comprising a plurality of ring diaphragms having inner edges and outer edges, wherein the inner edges define an inner opening and the inner edges and outer edges of adjacent ring diaphragms are alternately welded together, and at least one sliding ring which is secured in the inner opening of the diaphragm bellows and which has an inner surface for guiding the diaphragm bellows on a rod and an outer surface whose diameter is smaller than the diameter of the inner edge of the ring diaphragm and which is provided with an annular projection which protrudes radially outward or a plurality of projections which are spaced apart in circumferential direction, which projection or projections protrude(s) into the space between two ring diaphragms and secure(s) the sliding ring in a positive engagement against a displacement in axial direction of the diaphragm bellows, wherein the inner edges of the two ring diaphragms between which the projection or projections of the sliding ring is or are arranged rest on the outer surface of the sliding ring, and the inner edges of adjacent ring diaphragms are also arranged over the outer surface of the sliding ring in the contracted state of the diaphragm bellows.

2. Diaphragm bellows according to claim 1, wherein the sliding ring has at least one indentation at its inner surface in order to form a passage for air between the sliding ring and rod.

3. Diaphragm bellows according to claim 2, wherein the sliding ring has at least three indentations spaced apart in circumferential direction at its inner surface in order to form a passage for air between the sliding ring and the rod.

4. Diaphragm bellows according to claim 1, wherein facets which are inclined toward the side surfaces of the sliding ring are provided at the outer surface of the sliding ring and form run-in slopes for inner edges of ring diaphragms when the bellows is contracted.

5. Diaphragm bellows according to claim 1, wherein the outer surface of the sliding ring has a diameter that is smaller than the inner opening of the ring diaphragm, wherein the outer surface forms a centering surface for the ring diaphragm.

6. Diaphragm bellows according to claim 1, wherein a plurality of sliding rings which are spaced apart are arranged in axial direction of the diaphragm bellows.

7. Diaphragm bellows according to claim 6, wherein the distance between the sliding rings ranges from one to three times the outer diameter of the diaphragm bellows.

8. Diaphragm bellows according to claim 7, wherein the distance between the sliding rings ranges from one and a half to two times the outer diameter of the diaphragm bellows.

9. Diaphragm bellows according to claim 1, wherein the sliding ring is made of plastic, preferably Teflon.

10. Diaphragm bellows according to claim 1, wherein the sliding ring is made of metal.

11. Method for producing an elastically deformable diaphragm bellows from a plurality of ring diaphragms that are welded together, wherein two or more partial bellows are initially produced from ring diaphragms that are welded together, at least one sliding ring is then placed between two partial bellows, wherein a sliding ring has, at its outer surface, an annular projection which protrudes radially outward or a plurality of projections which are spaced apart in circumferential direction, and the projection or projections protrude(s) into the space between the two adjacent edge-side ring diaphragms of the partial bellows, and the two adjacent edge-side ring diaphragms of these partial bellows are subsequently welded together at their outer edges, wherein the sliding ring is secured in a positive engagement against a displacement in axial direction of the diaphragm bellows.

12. Method according to claim 11, wherein a sliding ring is placed between two partial bellows.

13. Method according to claim 11, wherein the projection or projections is or are arranged in a central area of the sliding ring, considered in axial direction, and two partial bellows which are to be welded together are centered relative to one another by the outer surface of the sliding ring adjoining the projection or projections on both sides.
